(19) United States
(12) Patent Application Publication
(10) Pub. No.: US 2020/0327022 A1
(43) Pub. Date: Oct. 15, 2020

(54) SYSTEM FOR MANAGING SERVICES IN A VIRTUAL MACHINES PLATFORM BASED ON AN ORACLE ENVIRONMENT

(71) Applicant: ATOS INTERNATIONAL B.V., Utrecht (NL)

(72) Inventors: Erik CRAMER, Utrecht (NL); Daan SLAGTER, Utrecht (NL); Jorrit VAN SURKSUM, Zwolle (NL)

(21) Appl. No.: 16/958,767

(22) PCT Filed: Dec. 28, 2018
(86) PCT No.: PCT/IB2018/060685

§ 371 Date: Jun. 29, 2020

(30) Foreign Application Priority Data
Dec. 29, 2017 (FR) 1763376

(51) Int. Cl. G06F 11/14; G06F 11/07; G06F 11/20; G06F 9/455; G06F 9/445

(52) U.S. Cl. CPC G06F 11/1484; G06F 11/1469; G06F 11/0712; G06F 11/0793; G06F 2009/45591; G06F 11/2023; G06F 9/45558; G06F 9/44505; G06F 11/079

(57) ABSTRACT

The present invention concerns a system and/or a process for managing services of a VM platform implemented in a VM infrastructure, characterized in that: virtual servers (vServer) are monitored by a management software (VMmanager) which is installed in a physical server outside the VM infrastructure it manages by recording the configurations of the virtual servers (vServer) in a repository (VMrep) stored in an Oracle Database (ODB) which is managed and used through a Relational DataBase Management System (RDBMS) service; said management of said services by the system is performed by framework of service management software (ASM) comprising at least one Configuration Management Module (CMM) storing, in said VM repository (VMrep), configuration items (CI) concerning the configurations of the virtual server (vServer) and their services, to provide an Incident Management Module (IMM) with up-to-date information for restoring a failed or failing service.

### TECHNICAL FIELD

The present invention concerns the field of Virtual Machines (hereinafter designated as VM) platforms and infrastructures, such as those based on the Oracle VM and Oracle databases. More specifically, the present invention concerns the management of the virtual servers (vServers) and their associated services, called VM services, which are made available through a communication network, for various purposes which are specific to the economical or industrial activity of the entities using such vServers and VM services and don't need to be detailed in the present description.

### TECHNICAL BACKGROUND

A problem in the field of the present invention is that the entities using such vServers and VM services require a their availability to be permanent and that the services are maintained at predetermined agreed levels. This requirement puts a constraint on the providers of such VM platforms and infrastructures who need to have an efficient and reliable management of the products and services that they offer.

### GENERAL DESCRIPTION OF THE INVENTION

One purpose of the present invention is to overcome some drawbacks of the prior art by proposing a system and/or a process for managing.

This purpose is achieved by a system for managing services of a VM platform through an Oracle Management Environment, said VM platform being implemented in a VM infrastructure including physical servers and/or at least one appliance, such as Oracle Exadata or Private Cloud for example, in which Oracle Virtual Machines are hosting several virtual servers which deliver said services, characterized in that:
said virtual servers are monitored by an Oracle VM management software which is installed in a physical server outside the VM infrastructure it manages, and preferably in said Oracle Management Environment;
said Oracle VM management software manages the configurations of the virtual servers in a repository stored in an Oracle Database which is managed and used through a Relational DataBase Management System service;
said management of said services by the system is performed by framework of service management software comprising at least one of the following modules:
   an Incident Management module for ensuring that a failed or failing service is restored within the service levels;
   a Configuration Management Module storing, in said VM repository, configuration items concerning the configurations of the virtual server and their services, to provide said Incident Management Module with up-to-date information for restoring said failed or failing service.

According to another feature, said Incident Management Module covers all actions necessary to ensure that a failed or failing service is restored within the service levels, among the following actions: Restart, Restore, Recover, Patch.

According to another feature, said framework of service management software comprises a Change Management Module for managing changes to configuration items with minimum disruptions, risks and complexity while maintaining said service within its levels.

According to another feature, said Change Management Module manages the changes by a failover to another Oracle Virtual Machine so as to perform the changes and test their efficiency, so as to switch over to the changed version if the efficiency reaches the service's levels.

According to another feature, said framework of service management software comprises a Problem Management Module for preventing occurrence or recurrence of incidents by eliminating their root cause.

According to another feature, the system manages said services through said Oracle Management Environment by using an enterprise service bus and/or an event router.

According to another feature, the system uses a technology framework for monitoring and/or reporting said services.

According to another feature, said technology framework provides, as necessary, a Management Data Repository which enables an update of said VM repository.

According to another feature, said framework of service management software further comprises at least one of the following modules:
service set-up module,
production support module,
security management module,
supplier liaison module,
patch management module,
back-up & recovery module

According to another feature, said back-up & recovery module builds up a virtual server from scratch, during a recovery, by using said Configuration Items stored in said VM repository.

According to another feature, when a virtual server is recovered by said back-up & recovery module, the operating system and application or database, are then restored and recovered using their respective dedicating services within the VM platform.

### DESCRIPTION OF THE ILLUSTRATIVE FIGURES

Other features and advantages of the present invention may appear more clearly when reading the description below, in reference to the annexed figures, in which:

FIG. 1 represents an overall view of the system according to an embodiment of the invention;

FIGS. 2a and 2b represents two schematic overall view of VM platform as managed by the system according to an embodiment of the invention, during a failover between vServers,

FIG. 3 represents a workflow of the repository updates performed by the system according to an embodiment of the invention,

FIG. 4 illustrates the flexibility offered by the repository updates performed by the system according to an embodiment of the invention,

FIG. 5 illustrates the deployment of the system according to an embodiment of the invention.

### DETAILED DESCRIPTION OF PREFERRED EMBODIMENTS

Various embodiments of the present invention concern a system and/or a process (i.e., method) for managing services of a VM platform through a management environment such as the Oracle Management Environment (OME). The Oracle software and systems (namely databases, Virtual Machines and so one) are well known in the field and those of skills in the art will recognize that the reference made herein to them are illustrative and should not be considered as limitative. Various embodiments of the present invention concern the management of VM platforms, which are usually implemented in a VM infrastructure including physical servers (VS) and/or at least one appliance in which Oracle Virtual Machines (OVM) are hosting several virtual servers (vServer) which deliver said services. The term “appliance” is used here in its general meaning of “an integrated system of hardware and software components running Oracle VM as Hypervisor. Examples of such appliance are:
Exadata=Oracle Database Systems
Exalogic=Oracle application and Middleware System
Super Cluster=Multi Purpose system based on Sparc/Solaris
PCA=Private Cloud Appliance
ODA=Oracle Database Appliance

The use of such appliance (EA), in some embodiments, allows to implement an Extreme Performance Computing environment (EPCe). The use of several physical servers in some embodiments allows to ensure a reliable availability of the vServers, as known in the field. Advantageously, the present invention is independent on the number of physical servers or appliances which form the VM infrastructure.

In various embodiments, the system and/or process for the management of the present invention, is characterized in that:
said virtual servers (vServer) are monitored by an Oracle VM management software (VMmanager) which is installed in a physical server outside the VM infrastructure it manages, and preferably in said Oracle Management Environment (OME);
said Oracle VM management software (VMmanager) manages the configurations of the virtual servers (vServer) in a repository (VMrep) stored in an Oracle Database (ODB) which is managed and used through a Relational DataBase Management System (RDBMS) service;
said management of said services by the system is performed by framework of service management software (ASM) comprising at least one of the following modules:
   an Incident Management module (IMM) for ensuring that a failed or failing service is restored within the service levels;
   a Configuration Management Module (CMM) storing, in said VM repository (VMrep), configuration items (CI) concerning the configurations of the virtual server (vServer) and their services, to provide said Incident Management Module (IMM) with up-to-date information for restoring said failed or failing service.

Such system, through the use of the specific repositories and dedicated scripts (for example a translation environment such as those in the art, like Ansible of Terraform) allows to optimize the update of the CMDB and the whole system.

SSRs are applied to Oracle DB's running on the OCC and ExaCC infrastructure that is proposed by Oracle to HSS. Oracle Database Automation is executed for a number of SSR (Standard Service Requests).

Those requests are automated using a combination of tools on different levels:
ServiceNow: Master Data and Process Orchestration
Ansible/Terraform: Scripting, Execution and Technical Orchestration
Bitbucket: Managing Ansible Playbooks

FIG. 5 illustrates the architecture of the system according to some embodiments. In the present automation process, the system includes Oracle Databases on a Virtual Oracle Computing Private Cloud (“Hotel”), Standard DB Infrastructures and IaaS solutions using a dedicated Oracle Database toolset (Nagios, OEM).

If we add OCC/ExaCC to this we have 2 different situations:
Using OCC as IaaS platform, the system uses the Process DB automation (Nagios, OEM)
Using Oracle DBCS (Database Cloud Services) the system needs to use the Cloud Machine DB API's.

Some advantages of such embodiments will now be described with reference to the non-limiting example of ServiceNow. Indeed, the standard ServiceNow CMDB has not enough flexibility to handle complex legacy environments and to cater for needs of technical staff. There are many data formats necessary to describe all different possible Configuration Item (CI) in non-standardized Legacy environments that Atos is managing. The present invention, in particular with its repositories, enables to overcome these problems. The solution is a NoSQL Repository (VM repository (VMrep) managed by the Configuration Management Module—CMM) to cater for this unstructured data. By applying a JSON definition of the technical details of every Configuration Item (CI), the system receives the flexibility to handle legacy environments and the standardization to enable automation via ServiceNow (Service Management Solution) and the performance to register complex configuration changes. The VM repository stores technical data to support the E2E automation and authorization of SSR's (Standard Service Requests). This detailed data is used for populating the Service Now (SNOW) GUI to enable the end user is able to select the proper action. Example: To be able to delete a Database user a dropdown list of existing users should be available. Since this data is too detailed to store into the CMDB, the RepoDB will be used to store this information. FIG. 4 illustrates the flexibility of the system. Within the GUI of Service Now, specific detailed data should be visible and selectable. There is not enough data in the current CMDB for this. The technical Database data should be up to date (depending on the type of data) and the system therefore generates timestamps. This technical Database data can be of different types (Database, Host, SW sets). To ensure the system does not need to refresh a big amount of data after each modification, the JSON Format can be chosen to depict the detailed technical configuration. Data should be refreshed on demand (end user) or as part of a workflow (after a change).

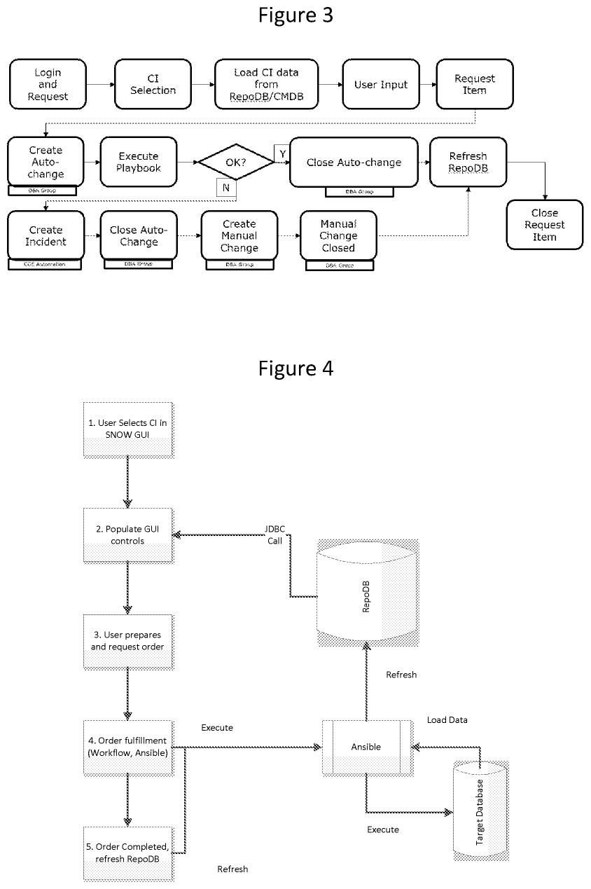

Thanks to this kind of configuration, the system enables the implementation of various processing optimizing the management of any change in the system. The invention thus also concerns a process implemented by the system described in at least one embodiment. FIG. 3 illustrates a workflow showing, firstly, the repository updates as explained in the present description and, secondly, the possibility of a manual override in case of failure. The workflow follows the steps of:

Request from a logged-in user: Both Customers and the System's Managers or Operators are able to use the SSR's. Possible catalog items are filtered based on user's role.
1. CI Selection: Configuration Items (CI) are filtered based on the functional role of the customer or the change group of the System's Managers or Operators.
2. Load CI data from RepoDB/CMDB: Data available in the CMDB and RepoDB is shown to the user (depending on the SSR).
3. User Input: The user's input can be verified and checked against RepoDB or CMDB data. User may be informed regarding planned outages, both database as depending on CIs (server, application).
4. Request Item: The system generates a Request Item so as to perform the requested task.
5. Create Auto-change: SSR's changing configurations should have a change registered and assigned to the proper DBA group. A Black-out period will be created if required by the SSR in the monitoring set-up to avoid monitoring alerts of planned outages.
6. Execute Playbook: The system Translates the request. Playbook will provide the status and additional information to ServiceNOW.
   Then, if the task is successfully performed:
7. Close Auto-change: Auto change will be updated with final status and closed.
8. Refresh RepoDB: The system updates the VM repositories. User data in RepoDB will be refreshed by insertion of a new JSON spec with timestamp and visible by ServiceNOW.
   But, if the task is not successfully performed, the system can further perform the following steps:
9. Create Incident: Create an incident for the CoE Automation to improve the automation
10. Close Auto- Change: The system closes the auto-change and indicates an incomplete status
11. Manual Change: The system creates a manual change for the DBA group (change category)
12. Close Manual Change: As soon as the manual change is closed, the request will continue to step 8 of refresh of the repositories.

In both cases of success or failure, the process may end by a final step:
13. Close Request Item.

In some embodiments, said Incident Management Module (IMM) covers all actions necessary to ensure that a failed or failing service is restored within the service levels, among the following actions: Restart, Restore, Recover, Patch.

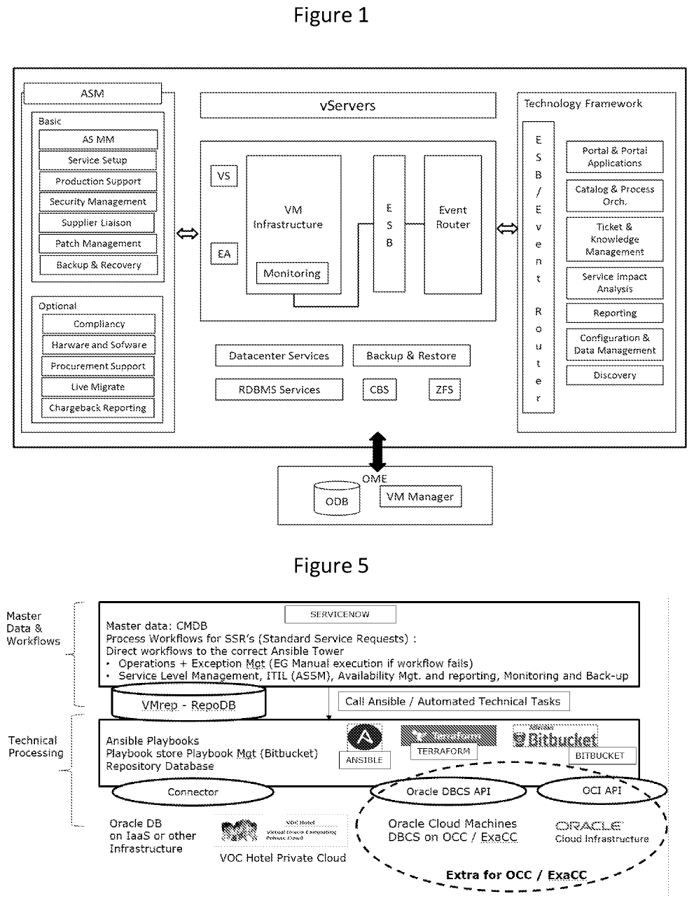

In some embodiments, the system generally uses a technology framework for monitoring and/or reporting said services. For example, said technology framework provides, as necessary, a Management Data Repository (MDR) which enables an update of said VM repository (VMrep). Generally, the system manages said services through said Oracle Management Environment (OME) by using an enterprise service bus (ESB) and/or an event router (ER), as shown in FIG. 1.

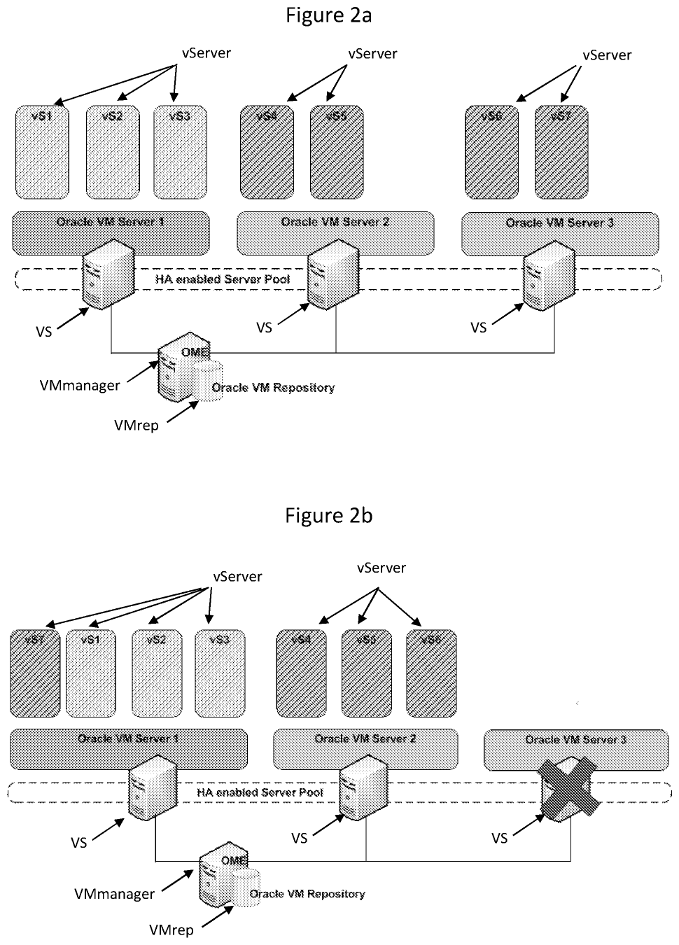

In some embodiments, said framework of service management software (ASM) further comprises other general service management modules. A first example of such modules is a Change Management Module (CMM) for managing changes to configuration items (CI) with minimum disruptions, risks and complexity while maintaining said service within its levels. In some of these embodiments, said Change Management Module (CMM) manages the changes by a failover to another Oracle Virtual Machine (OVM) so as to perform the changes and test their efficiency, so as to switch over to the changed version if the efficiency reaches the service's levels. An example of failover is shown in FIGS. 2a and 2b. A second example of such general modules of said framework of service management software (ASM) is a Problem Management Module (PMM) for preventing occurrence or recurrence of incidents by eliminating their root cause. Two other examples are a Query Management module for providing answers to customer questions regarding this service and a Complaint Management Module, for attempting to resolve expressions of dissatisfaction. A complaint always receives management attention on an appropriate level.

In some embodiments, said framework of service management software (ASM) further comprises other modules, for example concerning the service operations or concerning a service-specific management. The modules concerning the service operations may comprise at least one of the following modules:
service set-up module,
production support module,
security management module,
supplier liaison module,
patch management module,
back-up & recovery module

In some embodiments, these service operations modules may be responsible for the following functions:

| | |
|---|---|
| Production | Operational activities including regular housekeeping |
| Support | of the servers and storage, maintenance activities and |
| | controlling the correct functioning of these tasks. |
| Security | The present system manages the operating system |
| Management | environment in accordance with ISO 27001 standards, |
| | which are a set of administrative security guidelines |
| | that help maintain a high level of security at an |
| | organizational and technical level. |
| Supplier | When incidents or problems related to this service |
| Liaison - | require attention of a support supplier(s), The present |
| Operational | system will notify the Oracle to provide hardware |
| | and/or software support by passing on incidents or |
| | problems on behalf of the customer. |
| Patch | To keep Oracle VM infrastructure up to date twice a |
| Management | year the various components will be patched. |
| Backup & | Backup and Recovery guarantees that The present system |
| Recovery | is able to recover the Oracle VM infrastructure to a |
| | stable state in the event of a technical problem. This |
| | state is a prerequisite for proper reactivating the |
| | Virtual Machines running in the virtual infrastructure. |

In some embodiments, said back-up & recovery module builds up a virtual server (vServer) from scratch, during a recovery, by using said Configuration Items (CI) stored in said VM repository (VMrep). Some configurations Items (CI) are combined together to form templates of configurations which are used to restore services or recover vServers. The templates can thus concern some application (or software) responsible for one of said services or a database but can also concern the operating system itself. Such templates can thus be Linux templates, Windows templates, Oracle DB Templates, etc. In some embodiments, when a virtual server (vServer) is recovered by said back-up & recovery module, the operating system and application or database, are then restored and recovered using their respective dedicating services within the VM platform. These dedicated services are for example the standard services proposed by Oracle, such as OS management (either agent managed or agentless managed), Application Performance Management, Database management, etc.

In some embodiments, the modules concerning a service-specific management may comprise at least one of the following modules:
Availability Management module,
Capacity Management module
Performance Management module
Reporting module
Standard Service Requests/Transactions module

These service-specific management modules may be responsible for the following functions:

| | |
|---|---|
| Availability | Availability Management consists of all activities |
| Management | necessary to ensure that the Service Availability levels |
| | are met |
| Capacity | Capacity Management ensures that system resources for |
| Management | the VM environment is provided at the right time in the |
| | right volume |
| Performance | Enables the adjustment and optimization of the VM |
| Management | resources like CPU and I/O usage to comply with defined |
| | service performance quality and service levels agreed |
| | with customers. |
| Reporting | Provides advice on efficient use of specific VM features |
| | to improve database performance. |
| Standard | Small changes and operational requests, initiated by the |
| Service | customer, are called standard service requests (SSRs). |
| Requests/ | SSRs cover the most requested additional activities and |
| Transactions | are billed per request. |

Another type of modules can also concern the service implementation phase. Then, a service setup module may be part of the service management software (ASM), so that, before the continuous part of the Service can be delivered, a Service Set-up phase will be completed.

In some embodiments, said framework of service management software (ASM) may further comprise some optional modules, for example concerning the general service management. Such modules may for example correspond to the following modules and functions:

| | |
|---|---|
| Procurement | On request, The present system delivers procurement |
| Support | support. The Procurement Support option focuses on |
| | activities related to the purchase of hardware, software |
| | and maintenance. |
| Compliancy | The present system delivers a technical report which can |
| | be used as input for the ISAE3402 reporting. |
| Chargeback | For internal chargeback on customer level. The present |
| Method | system will supply the customer with chargeback |
| | methods. |
| Hardware and | The present system will provide the required server |
| Software | hardware, software, licenses and support contracts. |
| | Delivery of this service component will take place in |
| | consultation with the customer. |
| Live Migrate | A virtual machine can be moved to another Oracle VM |
| | Server within the same Server Pool without downtime to |
| | ensure on-going availability during Oracle VM server |
| | maintenance. |

The present application describes various technical characteristics and advantages with reference to the figures and/or to various embodiments. One skilled in the art will understand that the technical characteristics of a given embodiment may in fact be combined with characteristics of another embodiment unless the opposite is explicitly mentioned or it is obvious that these characteristics are incompatible. Further, the technical characteristics described in a given embodiment may be isolated from the other characteristics of this embodiment unless the opposite is explicitly mentioned.

After appreciating this disclosure, it should be obvious for those skilled in the art that other embodiments in many other specific forms may be configured without departing from the scope of the claims. Therefore, the present embodiments should be considered as illustrations, which may be modified without departing from the scope of the appended claims, and this disclosure should not be limited to the details given above.

1. System for managing services of a VM platform through an Oracle Management Environment (OME), said VM platform being implemented in a VM infrastructure including physical servers (VS) and/or at least one appliance, in which Oracle Virtual Machines (OVM) are hosting several virtual servers (vServer) which deliver said services, characterized in that:
said virtual servers (vServer) are monitored by an Oracle VM management software (VMmanager) which is installed in a physical server outside the VM infrastructure it manages, and preferably in said Oracle Management Environment (OME);
said Oracle VM management software (VMmanager) manages the configurations of the virtual servers (vServer) in a repository (VMrep) stored in an Oracle Database (ODB) which is managed and used through a Relational DataBase Management System (RDBMS) service;
said management of said services by the system is performed by framework of service management software (ASM) comprising at least one of the following modules:
an Incident Management module (IMM) for ensuring that a failed or failing service is restored within the service levels;
a Configuration Management Module (CMM) storing, in said VM repository (VMrep), configuration items (CI) concerning the configurations of the virtual server (vServer) and their services, to provide said Incident Management Module (IMM) with up-to-date information for restoring said failed or failing service.

2. System for managing services according to claim 1, characterized in that said Incident Management Module (IMM) covers all actions necessary to ensure that a failed or failing service is restored within the service levels, among the following actions: Restart, Restore, Recover, Patch.

3. System for managing services according to any one of claims 1 and 2, characterized in that said framework of service management software (ASM) comprises a Change Management Module (CMM) for managing changes to configuration items (CI) with minimum disruptions, risks and complexity while maintaining said service within its levels.

4. System for managing services according to claim 3, characterized in that said Change Management Module (CMM) manages the changes by a failover to another Oracle Virtual Machine (OVM) so as to perform the changes and test their efficiency, so as to switch over to the changed version if the efficiency reaches the service's levels.

5. System for managing services according to any one of claims 1 to 4, characterized in that said framework of service management software (ASM) comprises a Problem Management Module (PMM) for preventing occurrence or recurrence of incidents by eliminating their root cause.

6. System for managing services according to any one of claims 1 to 5, characterized in that it manages said services through said Oracle Management Environment (OME) by using an enterprise service bus (ESB) and/or an event router (ER).

7. System for managing services according to any one of claims 1 to 6, characterized in that it uses a technology framework for monitoring and/or reporting said services.

8. System for managing services according to claim 7, characterized in that said technology framework provides, as necessary, a Management Data Repository (MDR) which enables an update of said VM repository (VMrep).

9. System for managing services according to any one of claims 1 to 8, characterized in that said framework of service management software (ASM) comprising at least one of the following modules:
service set-up module,
production support module,
security management module,
supplier liaison module,
patch management module,
back-up & recovery module

10. System for managing services according to claim 9, characterized in that said back-up & recovery module builds up a virtual server (vServer) from scratch, during a recovery, by using said Configuration Items (CI) stored in said VM repository (VMrep).

11. System for managing services according to claim 10, characterized in that, when a virtual server (vServer) is recovered by said back-up & recovery module, the operating system and application or database, are then restored and recovered using their respective dedicating services within the VM platform.
